(19) United States
(12) Patent Application Publication
(10) Pub. No.: US 2013/0089171 A1
(43) Pub. Date: Apr. 11, 2013

(54) Compact Fusion Reactor

(71) Applicants: Alan Sykes, Wantage (GB); Mikhail Gryaznevich, Abingdon (GB)

(72) Inventors: Alan Sykes, Wantage (GB); Mikhail Gryaznevich, Abingdon (GB)

(73) Assignee: TOKAMAK SOLUTIONS UK LIMITED, Oxfordshire (GB)

(21) Appl. No.: 13/700,785

(22) PCT Filed: May 26, 2011
(86) PCT No.: PCT/GB2011/050990

§ 371 Date: Dec. 6, 2012

(30) Foreign Application Priority Data
Jun. 11, 2010 (GB) 1009768.1
Dec. 23, 2010 (GB) 1021854.3

(51) Int. Cl. G21B 1/05

(52) U.S. Cl. CPC G21B 1/057
USPC 376/133

(57) ABSTRACT

A compact nuclear fusion reactor for use as a neutron source is described. The reactor comprises a toroidal plasma chamber (34) and a plasma confinement system (31) arranged to generate a magnetic field for confining a plasma in the plasma chamber (34). The plasma confinement system (31) is configured so that a major radius of the confined plasma is 0.75 m or less. The reactor is configure to operate with a plasma current of 2 MA or less. The magnetic field includes a toroidal component of 5 T or less. Despite these low values, the reactor can generate a neutron output of 1 MW or more.

### TECHNICAL FIELD

The present application relates to a compact fusion reactor. In particular, although not exclusively, the invention relates to a spherical tokamak reactor suitable for use as a neutron source.

### BACKGROUND

World Fusion research has entered a new phase after the beginning of the construction of the ITER project. However, the successful route to a commercial fusion reactor demands long pulse, stable operation combined with the high efficiency required to make electricity production economic. These three conditions are especially difficult to achieve simultaneously, and the programme will require many years continuation of experimental research on ITER and other fusion facilities, as well as theoretical and technological research.

A more immediate application of fusion is the use of a fusion device as a neutron source, for a variety of applications (including isotope production) but most obviously to aid the present expanding fission programme, which is rapidly both exhausting uranium fuel and building up stores of radioactive waste; application of fast fusion neutrons can convert the huge stockpiles of depleted uranium into fresh fuel, and can help reduce waste problems by transmutation (McNamara [1]). Such applications have long been envisaged—the original fusion reactor patent of Thompson & Blackman in 1946 [2] recognised its value as a neutron source—but have largely been neglected, in the desire to search for ‘pure’ fusion as an ideal energy source.

In order for a fusion reactor to be viable as a neutron source, it is desirable to produce a device that is economic to build and operate whilst producing sufficient neutron yield. In particular, it would be desirable to evaluate largely untested areas such as steady-state operation, plasma control, tritium operation, etc whilst producing at least 1 MW of fusion neutrons ideal for scientific research, materials tests, production of isotopes, etc. 14 MeV (fast) fusion neutrons are produced when deuterium-tritium (D-T) plasma becomes very hot so that the nuclei fuse together, releasing the fast neutrons. The plasma needs to have high confinement time, high temperature, and high density to optimise this process.

One way of achieving this is to use a tokamak. A tokamak features a combination of strong toroidal magnetic field B_{T} (several Tesla) and high toroidal plasma current Ip (several mega-amps), and usually large plasma volume and significant auxiliary heating, to provide a hot stable plasma so that fusion can occur. The auxiliary heating (usually via tens of megawatts of neutral beam injection of very high energy neutral H or D or T) is necessary to increase the temperature to sufficiently high values. An exception is the IGNITOR project, which features an extremely large toroidal field (˜13 Tesla) and is predicted to be able to reach ignition without auxiliary heating.

The problem is that because of the large magnetic fields and high plasma currents generally required, build costs and running costs are very high and the engineering has to be very robust to cope with the large stored energies present, both in the magnet systems and in the plasma, which has a habit of ‘disrupting’—mega-ampere currents reducing to zero in a few thousandths of a second in a violent instability.

The situation can be improved by contracting the car-inner-tube torus of a conventional tokamak to its limit, having the appearance of a cored apple—the ‘spherical’ tokamak (ST). The first realisation of this concept at Culham demonstrated a huge increase in efficiency—the magnetic field required to contain a hot plasma can be reduced by a factor of 10. In addition, plasma stability is improved, and build costs reduced. The major drawback of the ST is that space constraints on the central column prohibit installation of the substantial shielding necessary to protect the central windings in a neutron environment—so conventional toroidal field windings, and conventional central solenoids (used to induce and maintain the plasma currents) are not practical. However, power plants based on the ST have been designed (using solid copper centre posts with limited shielding, the post being changed every year or so when damaged by neutrons). The drawback with this is that the high energy dissipation in the centre column due to the relatively high resistivity of warm copper, requires a large device for electricity production to become economical.

A more practical application of the ST is as a neutron source, as discussed in the previous section. Several designs have been made, as discussed below. Although field and current requirements are greatly reduced from those required in a power plant, they are still substantial, and in addition to the obvious installation costs and running costs, the energy input to the plasma to provide current drive and auxiliary heating is typically tens of Megawatts. In a steady state this power leaves the plasma at the same rate—and in a fusion plasma it mostly emerges along a very narrow region at the edge of the plasma, the ‘scrape-off layer’ which intersects the vacuum vessel in the divertors in a very small footprint, depositing possibly many megawatts of heat on a small area.

### SUMMARY

For a ST-based fusion Neutron Source to be practical it is desirable to solve at least some of the following problems:
Initiating the plasma current without a conventional central solenoid.
Ramping up the current to the required value.
Maintaining the current with minimal power input.
Heating the plasma to produce neutrons at minimal power input.
Ensuring that the heat load from the plasma on the divertor regions is tolerable.
Designing a structure capable of protecting itself against neutron damage, whilst producing a fluence of neutrons for scientific and processing applications.

In accordance with a first aspect of the present invention there is provided a compact nuclear fusion reactor for use as a neutron source. The reactor comprises a toroidal plasma chamber and a plasma confinement system arranged to generate a magnetic field for confining a plasma in the plasma chamber. The plasma confinement system is configured so that a major radius of the confined plasma is 0.75 m or less, preferably 0.5 m or less, more preferably 0.3 m or less. The reactor is configured to operate with a plasma current of 2 MA or less, preferably 1.5 MA or less, more preferably 1 MA or less. The magnetic field includes a toroidal component of 5 T or less, preferably 3 T or less, more preferably 1.5 T or less.

Previous designs for small fusion reactors usually have a problem with wall loading—i.e. the dispersion of plasma heat through the walls of the plasma chamber. The use of a low magnetic field and low plasma current addresses this issue by reducing the amount of heat that needs to be dispersed. For the same reason, in some embodiments the power input to the plasma is 10 MW or less, or even 6 MW or less. The reactor may be a spherical tokamak.

The neutron output from such a reactor is preferably at least 1 MW. It is surprising that it is possible to obtain such a large neutron production from a reactor running at low current, magnetic field and input power. However, neutron production can be enhanced by directing a neutral beam into the plasma so as to interact with the high-temperature tail of the Maxwellian plasma distribution. The neutral beam may have an energy of at least 80 keV, preferably 100 keV, more preferably 130 keV.

In one embodiment, the plasma is maintainable in a steady state for more than 10 seconds, preferably more than 100 seconds, more preferably more than 1000 seconds. This dramatically increases the usefulness of the neutron production, since the total number of neutrons emitted increases with long pulses. In order to achieve such long pulses, the plasma current may be driven without induction. The plasma may be initiated using merging-compression, magnetic pumping so that an oscillating current produces plasma rings to augment the plasma current, activation of one or more retractable solenoids located in a central core of the toroidal chamber, and/or Electron Bernstein Wave current initiation by a gyrotron. The plasma current may be ramped up using activation of the one or more retractable solenoids, Electron Bernstein Wave current drive, and/or heating the plasma so that a rapid increase in poloidal field necessary to contain the plasma as it grows inputs almost sufficient flux to ramp up the plasma current to a desired working value. The retractable solenoids may include pre-cooled high temperature superconducting solenoids.

The neutral beam and/or plasma may include tritium to enhance neutron production. Tritium is expensive and radioactive, so it may be preferable to operate the reactor using deuterium only. Some neutrons will still be produced by D-D fusion reaction (approximately 1/80 as many as produced by D-T fusion under the same conditions of toroidal field, plasma current and plasma heating). However D-D fusion can be important for testing of reactors prior to the use of tritium and in circumstances where the use of tritium is undesirable, eg for reasons of cost, complexity, safety, regulation or availability.

There are certain circumstances where surprisingly high neutron fluxes can be achieved with D-D fusion. This can be achieved by increasing the toroidal field, by judicious use of neutral beam injection and by optimising the methods of plasma heating.

The neutrons emitted by the reactor may be used, inter alia, for formation of isotopes for medical and other use, production of hydrogen (for example by electrolysis), treatment of nuclear waste, manufacture of tritium by neutron bombardment of lithium, breeding of nuclear fission fuel, neutron spectroscopy, testing of materials and components, and/or scientific research.

In conventional fusion reactors, a-particles generated in the plasma are retained. Although they assist with the plasma heating, they can also produce instability and contamination problems as they accumulate. Since the plasma current and magnetic fields are so low in the proposed device, the α-particles are optionally not confined.

While the reactor is running, there should optionally be no solenoid in the centre of the torus, since it would be damaged by the high neutron fluence.

The fusion reactor may comprise divertor plates optimised to reduce the load per unit area on the walls of the plasma chamber, and/or divertor coils configured to direct an exhaust plume of the plasma and expand a footprint of said exhaust plume to large radius and/or sweep the contact region over the exhaust area. One or more of the divertors may be coated with liquid Lithium.

The reactor may also comprise a multiplier blanket configured to increase the flux of emitted neutrons (at the expense of individual neutron energy). Reflectors may be provided to direct neutrons out of the reactor in such a way as to produce local increases in flux density and/or to protect poloidal coils and other tokamak components from extensive neutron irradiation.

In accordance with another aspect of the present invention there is provided a method of generating neutrons by operating a nuclear fusion reactor comprising a toroidal plasma chamber. The method comprises initiating a plasma in the plasma chamber, generating a magnetic field with a toroidal component of 5 T or less, preferably 3 T or less, more preferably 1.5 T or less to confine the plasma in the plasma chamber, the plasma having a major radius of 0.75 m or less, ramping a plasma current in the plasma up to 2 MA or less, and emitting neutrons.

### BRIEF DESCRIPTION OF THE DRAWINGS

Some preferred embodiments of the invention will now be described by way of example only and with reference to the accompanying drawings, in which:

FIG. 1 illustrates the effect of tritium fraction on fusion power;

FIG. 2 illustrates the magnetic field line behaviour in conventional and spherical tokamaks; and

FIG. 3 is a cross-section through a spherical tokamak.

### DETAILED DESCRIPTION

Several options were considered for a 14 MeV neutron source on the basis of a tokamak with a fusion output of at least 1 MW, including:
a. A tokamak with superconducting magnets and an aspect ratio A=3-4 (A=R/a—ratio of large radius R of the torus to a small radius a);
b. A low aspect ratio tokamak with copper or superconducting magnets and an aspect ratio A=2;
c. A compact spherical tokamak with copper magnets and an aspect ratio A=1.5-1.8;
d. A spherical tokamak with copper or superconducting magnets with an aspect ratio of 1.5-1.8.

From a technical point of view, all options seem realizable, capable of providing the required power level. Option (a) has the lowest plasma and neutron loads, but its cost will exceed 1 billion euro.

Option (b) has certain advantages in manufacturing, as well as the reduced cost of the tokamak, as compared to option (a). However, due to its large size option (b) has significant power requirements for the magnetic system and current generation system. This leads to higher operating costs as power dissipation in magnets and power consumption of other systems can approach 500 MW.

Option (c) provides the smallest size with an acceptable power dissipation level up to 50 MW and minimum build cost, providing several megawatts of neutron power.

Option (d) may prove to be even more efficient, as energy consumption can be further reduced by using superconducting (or high-temperature superconducting) magnetic coils. This option requires more space for magnets and in particular, for the central stack, which leads to increased major radius of the device compared to the compact option (c). The major radius of a tokamak plasma is the radius of the tokamak as a whole (from the centre of the hole down the centre of the device to the centre of the plasma) and the minor radius is the radius of the plasma itself.

The present document focusses on option (c), a Compact Fusion Neutron Source (CFNS) based on the Compact Spherical Tokamak (ST) concept.

Before describing the device in detail, it is helpful to consider previous studies of fusion devices based on spherical tokamaks.

Stambaugh et al [3] in ‘The Spherical Tokamak Path to Fusion Power’ described a family of Spherical Tokamaks (STs) including a Pilot Plant with major radii of R ˜0.7 m (plasma current Ip˜10 MA, central toroidal field BTo˜2.8 T) which have significant output (400-800 MW) at an aggressive H-factor (increase in energy confinement over scaling law for conventional tokamaks) ˜7 and β_{N} (measure of efficiency: the ratio of plasma pressure contained to magnetic field pressure required) ˜9 and a wall loading of 8 MW/m2 (wall assumed to be at radius Ro+2a) and which are designed to produce electricity economically.

Hender et al [4] considered a Component Test Facility (CTF) based on a similarly modest sized ST (R ˜0.7 m, Ip˜10.3 MA, BTo-3 T, fusion output ˜40 MW at a modest H-factor ˜1.3, β_{N}˜2.6 and wall load (at Ro+2a) of ˜0.75 MW/m2) designed to produce sufficient neutron fluence to test Fusion Reactor components.

Wilson et al [10] extended the work of Hender at al to propose a CTF again of A ˜1.6, designed to consume <1 kg of Tritium per year and specifically to aid the fast-track approach to Fusion Power by testing components and materials. Their device has R ˜0.75 m, Ip˜8 MA, BTo˜2.8, H˜1.3, PNBI ˜60 MW, and yields Pfus ˜50 MW of which about 25% arises from beam-plasma interactions (discussed further below).

Voss et al [12] developed the Wilson design, increasing the size slightly to R=0.85 m, a=0.55 m, with a slight decrease in current and field to 6.5 MA and 2.5 T, again assuming H=1.3, with PNBI=44 MW and Pfus=35 MW.

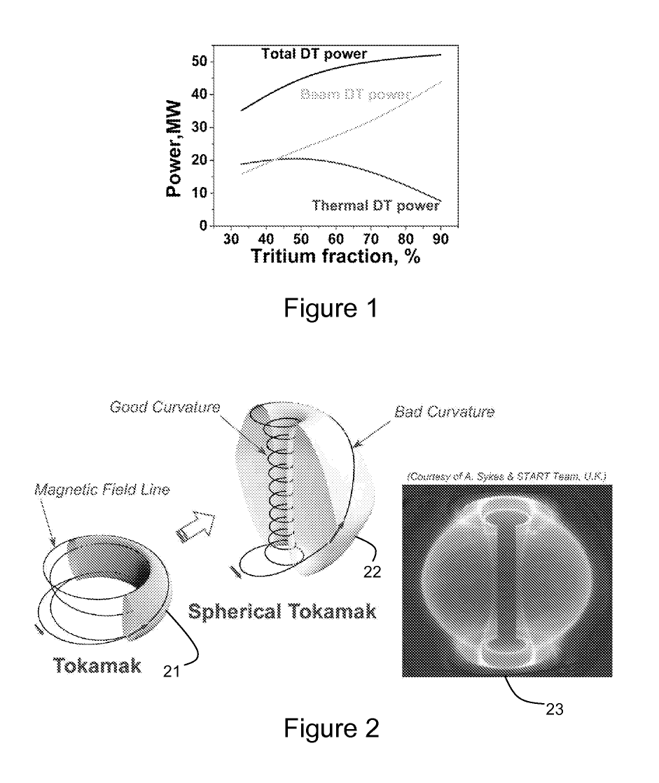

Dnestrovkij et al [15] provided a DINA code simulation of the Wilson CTF, and find by using a different mix of NBI energies (6 MW at 40 keV and 44 MW at 150 keV) they can provide current ramp-up and, aided by a larger Tritium fraction of 70% (cf 50%) obtain the same fusion output (50 MW) but at considerably lower plasma current (5.5 MA cf 8 MA). Although Tritium is scarce and expensive, the option of using a larger Tritium fraction to obtain the same neutron output but at lower plasma pressure (and hence improved plasma stability) is attractive. The fractions of thermal and beam-thermal neutrons in this study is shown in FIG. 1 as a function of Tritium fraction.

All the above studies employ NBI for current drive (providing heating, in conjunction with a-particle heating—note a-particles have low prompt losses at the high plasma currents employed in the first three studies), use well-understood technology (e.g. copper windings), and aspect ratios 1.4˜1.6 (at which sufficient Tritium can be bred without need of a centre-column blanket, although at the small sizes considered, Tritium consumption is low and could be met from existing resources).

Peng et al [16] proposed a larger CTF with R=1.2 m, A=1.5, k=3.07, Bt=1.1-2.2 T, Ip=3.4-8.2 MA, heating power 15-31 MW, bootstrap (self-driven current) fraction ˜0.5, Q (ratio of fusion power out to input power)=0.5-2.5, Pfus=7.5-75 MW. This CTF also has an option of tritium breeding.

Wu et al [13,14] proposed an ST for nuclear waste transmutation with R=1.4 m, A=1.4, k=2.5, Bt=2.5 T, Ip=9.2 MA, nₑ=1.1 10²⁰ m⁻³, bootstrap current fraction=0.81, heating power 19 MW and the wall load 1 MW/m². This design with an aspect ratio near the lower limit (due to limited space in the central post) requires an unshielded centre conductor post as part of the toroidal field magnet.

Most recently, Kotchenreuther et al [18] proposed a larger CFNS with 100 MW fusion output (Ro=1.35 m, aspect ratio 1.8, BTo=3.1 T, Ip=10-14 MA) using their ‘Super X’ divertor to solve the critical divertor thermal load problem. Their device is designed for use either as a CTF, the basis of a fusion-fission hybrid, or for development of a pure fusion reactor.

In the present case, the requirements are significantly less demanding than those in the above studies, especially the Stambaugh et al study which requires long-pulse operation close to stability limits and at high wall-loading to ensure cost-effective electricity production. Hender and Wilson require high neutron flux for long periods to provide sufficient component testing, and operate at high plasma current. In the present proposal, demands can be relaxed: what is required is lower power stable operation producing sufficient neutron fluence for isotope production or for processing fuel or waste. In addition, the option of operation away from stability and wall-load limits is explored, together with operation at lower plasma current to minimise operational costs and reduce possible disruptive loads. It is also important to minimise build cost.

### Two More Recent Studies are Particularly Relevant

Galvao et al [11] studied a ‘Multi functional Compact Tokamak Reactor Concept’ designed with the same objectives as our present study. They proposed a device of major radius Ro=1.2 (some 50% larger than MAST and NSTX), with A=1.6, Ip=5 MA, BTo=3.5 T, and obtained a fusion gain (Q) ˜1 for a range of auxiliary heating powers from 5 MW to 40 MW. Interestingly, at lower powers the maximum Q˜1 gain occurs at ever lower densities, whereas bootstrap current increases almost linearly with density—so the higher performance options have the advantage of largest self-driven current. However this study did not appear to consider the additional neutron production provided by beam-plasma interactions.

Kuteev et al [6] specifically addressed the need for a small facility developing up to 10 MW of fusion power whilst requiring total auxiliary heating and current drive power<15 MW and total power consumption<30 MW. They re-evaluated the smallest (Ro ˜0.5 m) member of the Stambaugh range but under extremely reduced conditions: Ip-3 MA, BTo˜1.35 T with a neutron fluence of ˜3×10¹⁷ n/s corresponding to a fusion power of ˜1 MW and a neutron load 0.1 MW/m². Modelling shows that neutron production is more than doubled by the beam-on-tail effect. Importantly for a first pilot device, the build cost was estimated at less than £200M.

Thus rather than operating at high plasma current, it may be possible to employ significant NBI auxiliary heating; accept higher prompt losses of a-particles, but enjoy significant neutron production from the NBI beam-on-tail interactions noted by Jassby [5]. This effect occurs when high energy beams slow down in a thermal tokamak plasma, and is very effective in the ST plasmas considered here.

An objective in building a CFNS prototype (CFNS-P) is to produce a significant neutron yield of at least 1 MW. Three conflicting demands are:
1) to minimize construction cost (which encourages small size)
2) to minimize thermal and neutron wall load per sq metre (which encourages large size)
3) to minimise running costs both of electricity and tritium (which encourages small size)

Kuteev described a tokamak with Ro=0.5 m. A scaled-up Ro˜0.75 design with similar neutron output has also considered, which has higher initial build cost but similar operational costs, with the advantages of lower thermal wall loading and capability of upgrade to higher performance: as shown in Stambaugh et al, the ratio of fusion power to centre-post dissipation increases as the 4th power of size, making the larger version very efficient. It will be noted that several authors proposed a compact version with major radius about 0.5 m, but then moved to a larger device both to reduce thermal loads on the divertors, and to obtain increased output. The current proposal shows that significant output can be achieved at much lower currents and fields than previously used, which lessens divertor load and makes a compact device feasible.

Key to the success in all the devices outlined above is the emergence of the Spherical Tokamak. The Spherical Tokamak represents a low aspect ratio version of a conventional tokamak.

The concept of a spherical tokamak (ST) was first introduced by Jassby [7] and later by Peng [8]. At the same time, a small low-aspect ratio tokamak GUTTA was constructed and operated at loffe Institute, Russia, confirming some of unique features of the ST concept. However, the first demonstration of the main advantages of a spherical tokamak (i.e. high beta, high natural elongation, improved stability and enhanced confinement—H-mode) should be attributed to the START device [9] which was operating at Culham Laboratory in 1990-1998. START was a small tokamak but achieved normalised plasma pressures βₜ˜40% (which is still a record for tokamaks). If the aspect ratio A=Rₒ/a of the plasma column (here Rₒ and a are the major and minor radii) is substantially reduced with respect to conventional tokamak aspect ratio range (A≈3÷4), there is a significant increase of plasma stability properties. The combination of simple construction, excellent results and high reliability confirmed on more than 15 small and medium sized STs operated during last decade produce a strong motivation for an ST as the next step in the Fusion Programme, and the high performance and small size makes the ST economical both in build cost and in Tritium consumption.

FIG. 2 illustrates an effect of aspect ratio reduction. The figure shows the peripheral magnetic field lines in a conventional tokamak 21 and in a spherical tokamak 22. In the conventional tokamak 21, magnetic field lines have comparable lengths in the region of a favourable curvature (inner, high field and stable region) and unfavourable curvature of magnetic field (outer unstable region). In the spherical tokamak 22 the field line path in the inner, stable region is significantly higher than in the outer, unstable region and the field line is generally wrapped onto the central core of the plasma column, where the toroidal magnetic field is high. As the particle motion in a magnetic trap is bound to the field lines, the most straightforward result of an aspect ratio decrease is an increase in the plasma column magneto-hydrodynamic (MHD) stability. This improved MHD stability permits either a significant increase in the plasma current, or a decrease in the toroidal magnetic field strength; this feature has been exploited in the very successful ST experiments, notably START at UKAEA Culham [9]. The figure shows the plasma column 23 in the START tokamak, with very sharp plasma edges, demonstrating the very good confinement properties (H-mode) obtainable in an ST plasma.

The list of parameters achieved on leading spherical tokamaks and proposed parameters for a CFNS prototype with major radius 0.5 and 0.75 m (CFNS-P5, CFNS-P75) are presented in the following table.

| | START | MAST | NSTX | QUEST | CFNS-P5 | CFNS-P75 |
|---|---|---|---|---|---|---|
| R, m | 0.35 | 0.8 | 0.75 | 0.68 | 0.5 | 0.75 |
| a, m | 0.27 | 0.6 | 0.55 | 0.4 | 0.3 | 0.47 |
| κ | 1.5-3 | 2.7 | 3.0 | 2.5 | 2.8 | 2.8 |
| Iₚ, MA | 0.31 | 1.5 | 1.5 | 0.3 | 1-2 | 2-3 |
| Bₜ,T | 0.2-0.6 | 0.6 | 0.5 | 0.25 | 1.5 | 1.35 |
| P_{NBI}, MW | 1 | 4 | 7 | 3 | 5-10 | 5-15 |
| Tₑ, keV | 1 | 3 | 7 | | | |
| β_{N} | 6 | 6 | 7 | | | |
| βₜ, % | 40 | 15 | 39 | | | |
| τₚ, s | 0.06 | 0.7 | 1.5 | s/s | s/s | s/s |

To date, STs have produced good physics performance but so far they have low magnetic fields, low heating power and most of them are short pulse devices. The neutron flux is negligible as tritium has not been used, and anyway modelling shows that even if a D-T mix could be employed, neutron yield would be very small, mainly because of the low toroidal field (neutron production scales approximately as the cube of the TF).

The proposed CFNS Prototype (CFNS-P) is the first ST to have high magnetic field, high availability, high neutron fluency, low running costs and so will be the world's most powerful neutron source—giving high performance at relatively low cost.

### Main Parameters

CFNS-P is a long-pulse spherical tokamak with an elongated plasma, and a double-null divertor. As a Prototype, its design objectives are to demonstrate routine steady-state operation in hydrogen (enabling optimisation and any necessary modifications to be made without problems of radioactivity), before proceeding to a Deuterium-Tritium (DT) mix where considerable neutron fluence would result. The design incorporates features (notably shielding/neutron reflectors and a heavy water surrounding blanket) which allow control of the neutron output for test purposes.

Standard operation produces a D-T fusion power of 1-5 MW for a burn length of longer than 1000 sec which is determined as a “quasi steady-state” for most engineering requirements. The injection of 6-10 MW neutral beams of 80 keV and above provides the main source of auxiliary power. Electron Bernstein Wave (EBW) heating is also considered. Reference tokamak parameters are provided in the following table:

| | CFNS-P5 | CFNS-P75 |
|---|---|---|
| Total fusion power | 0.5-2 MW | 1-5 MW |
| Q - fusion power/additional heating | <1 | <1 |
| power | | |
| Average 14 MeV neutron wall loading | <0.2 MW/m² | <0.2 MW/m² |
| Plasma major radius (R) | 0.5 m | 0.75 m |
| Plasma minor radius (a) | 0.3 m | 0.47 m |
| Plasma current (Ip) | 1-2 MA | 2-3 MA |
| Vertical elongation @ 95% flux | 2.8 | 2.8 |
| surface, κ₉₅ | | |
| Vertical elongation @ separatrix (κₛ) | 3.0 | 3.0 |
| Triangularity | 0.4 | 0.4 |
| Toroidal field in vacuum @0.5 m | 1.35-1.5 T | 1.35-1.5 T |
| radius (Bₜ) | | |
| Plasma volume, m³ | 2 | 6.8 |
| Plasma surface area, m² | 10 | 22.5 |
| Auxiliary heating/current drive power | 5-10 MW | 10-15 MW |

### Start-Up and Ramp-Up

Previous designs for neutron sources feature large plasma currents, comparable with that on the world's largest tokamaks. A feature of the present design is that much lower plasma current is required. However, it is planned to obtain start-up and ramp-up to these currents without use of a large central solenoid because, in the final design, the large neutron fluence prohibits the use of a conventional central solenoid, as there is insufficient space for the extensive shielding required to protect the windings (a possible exception could arise by the use of high-temperature-superconducting centre column windings, which being very compact could permit use of shielding, but this is considered an unnecessary complication for this present design).

However a major advantage of the use of a spherical tokamak is that the plasmas (having low aspect ratio and high elongation) have very low inductance, and hence large plasma currents are readily obtained—input of flux from the increasing vertical field necessary to restrain the plasma also being very significant at low aspect ratio [19].

Experiments on MAST have demonstrated start-up using a 28 GHz 100 kW gyrotron (assisted by vertical field ramp) at an efficiency of 0.7 A/Watt [20]. The gyrotron fitted to CFNS-P will have power 1 MW and so is predicted to produce a start-up current of ˜700 kA in CFNS-P.

An alternative scheme is to use a small solenoid (or pair of upper/lower solenoids) made using mineral insulation with a small shielding (or designed to be retracted before D-T operation begins); it is expected that such a coil would have approximately 25% of the volt-secs output as an equivalent solenoid as used on MAST, NSTX. Initial currents of order 0.5 MA are expected. The combination of both schemes would be especially efficient.

A novel development of the ‘retractable solenoid’ concept is to use a solenoid wound from High Temperature Superconductor (HTS), to cool it in a cylinder of liquid Nitrogen outside the tokamak, insert it into the centre tube whilst still superconducting, pass the current to produce the initial plasma, then retract the solenoid before D-T operation. Advantages of using HTS include lower power supply requirements, and the high stresses that can be tolerated by a steel-supported HTS winding.

This initial plasma current will be an adequate target for the lower energy NBI beams, and the heating and current drive they produce will provide current ramp up to the working level of 1-2 MA.

### Heating and Current Drive

As previously discussed, it is desirable to obtain a significant fluence of neutrons (say 1 MW) at minimum auxiliary heating and minimum current drive, in order to minimise build costs, running costs, and most importantly to keep divertor heat loads at tolerable levels. New modelling (utilising latest energy confinement scalings, optimising beam-on-tail effects, injection angle, density, and tritium ratios) indicates that significant neutron production ˜1 MW can be achieved for NBI injection powers as low as 5 MW.

Recent energy confinement scalings, derived from recent results on both MAST at CCFE and NSTX at Princeton suggest that energy confinement in an ST has a stronger dependence on magnetic field, and a lower dependence on plasma current, than the ITER scalings derived for conventional tokamaks, and hence is improved for the relatively high field and low current of the CFNS-P design.

Various methods of heating (and current drive) including NBI and a range of radio-frequency (RF) methods may be appropriate. NBI is the most widely used scheme and has the advantages of easy injection into the plasma, and less sensitivity to plasma parameters than most RF methods.

NBI is also the most commonly used method of current drive. Its efficiency depends on many parameters—beam energy, angle of injection, density of plasma; typically 1 MW of NBI may drive 0.1 MA of plasma current; and since NBI costs approx £3M per MW, this is a major cost. A potentially helpful feature is the self-driven ‘bootstrap’ current, produced in a hot high energy plasma, which can account for possibly one-half of the required current. However bootstrap current increases with density, whereas NBI current drive reduces at high density, so a careful optimisation is required. A major result which makes the present design feasible, is that modelling has shown that the plasma current required in CFNS-P is very low, at 1.5 MA, possibly as low as 1 MA; this makes the power required for current drive to be reduced to about 6 MW, which as seen above is sufficient to obtain the required neutron fluence. This very modest requirement on plasma current is also partly attributable to the improved confinement scaling.

### Thermal Load on Divertors

Energy pumped into a plasma either to heat it or produce current drive emerges mainly along the scrape-off-layer (SOL) at the edge of the plasma, which is directed by divertor coils to localised divertor strike points. The power per unit area here is of critical concern in all fusion devices, and would not normally be acceptable in a small neutron source. However since the plasma current in the present proposal is very small the input power is greatly reduced (of order 6 MW, compared to tens of MW in other designs) so the divertor load is correspondingly reduced. Additional methods are used to reduce the load per unit area further, by a combination of strike-point sweeping; use of the ‘natural divertor’ feature observed on START; and use of divertor coils to direct the exhaust plume (as advocated by Peng & Hicks [17]); possibly to expand the footprint to large radius as in the ‘super-X’ divertor advocated by Kotchenreuther et al [18]. This latter normally requires large currents in the divertor control coils, as these have to be somewhat removed from the neutron source for protection: however this demand is made tractable here because of the very low plasma current required. Further benefit may be gained by use of a flow of liquid Lithium over the target area which will also be used to pump gases from the vessel, for example in a closed Lithium flow loop.

### General Outline of CFNS-P

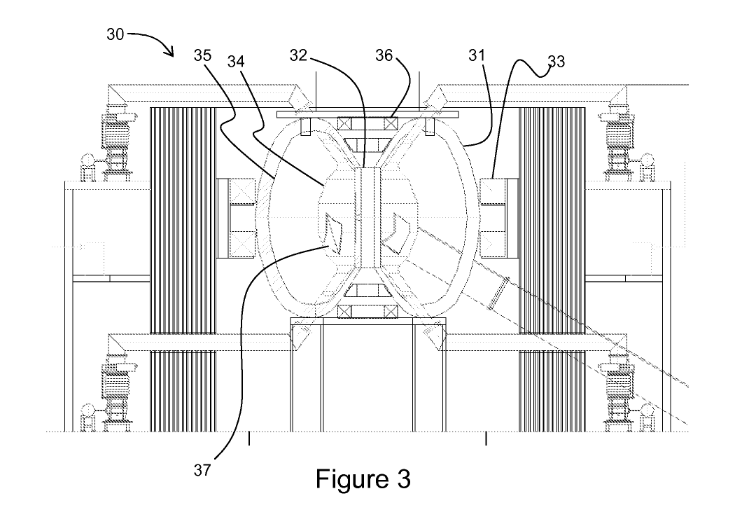

A cross section of a spherical tokamak 30 suitable for use as a neutron source is shown in FIG. 3. The major components of the tokamak are a toroidal field magnet (TF) 31, optional small central solenoid (CS) 32 and poloidal field (PF) coils 33 that magnetically confine, shape and control the plasma inside a toroidal vacuum vessel 34. The centring force acting on the D-shaped TF coils 31 is reacted by these coils by wedging in the vault formed by their straight sections. The outer parts of the TF coils 31 and external PF coils are protected from neutron flux by a D₂O blanket and shielding 35. The central part of TF coils, central solenoid and divertor coils 36 are only protected by shielding.

The vacuum vessel 34 is double-walled, comprising a honey-comb structure with plasma facing tiles, and is directly supported via the lower ports and other structures. Integrated with the vessel are neutron reflectors 37 that will provide confinement of fast neutrons which will provide up to 10-fold multiplication of the neutron flux through ports to the outer blanket where neutrons either can be used for irradiation of targets or other fast neutral applications, or thermalised to the low energy to provide a powerful source of slow neutrons. The reason for such assembly is to avoid interaction and capture of slow neutrons in the structures of the tokamak. The outer vessel contains D₂O with an option for future replacement by other types of blanket (Pb, salts, etc.) or inclusion of other elements for different tests and studies. The outer shielding will protect the TF and PF coils, and all other outer structures, from the neutron irradiation. The magnet system (TF, PF) is supported by gravity supports, one beneath each TF coil.

Inside the outer vessel, the internal components (and their water cooling systems), also absorb radiated heat and neutrons from the plasma and partially protect the outer structures and magnet coils from excessive neutron radiation in addition to D₂O. The heat deposited in the internal components and in the vessel is ejected to the environment by means of the cooling water system (CWS). Special arrangements are employed to bake and consequently clean, in conjunction with the vacuum pumping system, the plasma-facing surfaces inside the vessel by releasing trapped impurities and fuel gas.

The tokamak fuelling system is designed to inject the fuelling gas or solid pellets of hydrogen, deuterium, and tritium, as well as impurities in gaseous or solid form. During plasma start-up, low-density gaseous fuel is introduced into the vacuum vessel chamber by the gas injection system. The plasma progresses from electron-cyclotron-heating and EBW assisted initiation, possibly in conjunction with flux from small retractable solenoid(s), and for a ‘merging-compression’ scheme (as used on START and MAST), to an elongated divertor configuration as the plasma current is ramped up. A major advantage of the ST concept is that plasmas (having low aspect ratio and high elongation) have very low inductance, and hence large plasma currents are readily obtained—input of flux from the increasing vertical field necessary to restrain the plasma being very significant [19]. Addition of a sequence of plasma rings generated by a simple internal large-radius conductor may also be employed to ramp up the current.

After the current flat top (nominally 1-2 MA for standard operation) is reached, subsequent plasma fuelling (gas or pellets) together with additional heating leads to a D-T burn with a fusion power of about 1 MW. With non-inductive current drive from the heating systems, the burn duration is envisaged to be extended above 1000 s and the system is designed for steady-state operations. The integrated plasma control is provided by the PF system, and the pumping, fuelling (H, D, T, and, if required, He and impurities such as N₂, Ne and Ar), and heating systems based on feedback from diagnostic sensors.

The pulse can be terminated by reducing the power of the auxiliary heating and current drive systems, followed by current ramp-down and plasma termination. The heating and current drive systems and the cooling systems are designed for long pulse operation, but the pulse duration may be determined by the development of hot spots on the plasma facing components and the rise of impurities in the plasma.

Referring back to FIG. 1, it should be noted that the figure refers to a very large (50 MW) fusion device, and shows the total D-T fusion neutron power made up of a thermal-thermal part and a beam—hot-thermal-tail part. This shows that the two contributions are similar at 50-50 D-T mix but the interaction between the beam and the tail dominates at higher fractions of tritium. In the very compact device outlined in the present document, thermal contributions are lower and the beam-tail contribution dominates even at a 50-50 D-T mix.

Thus the approach outlined above enables the design of a Compact Fusion Neutron Source (CFNS) that is much smaller than previous designs, having correspondingly lower construction and operational costs (volume from ⅕ to 1/15 of existing designs, magnetic field energy and tritium consumption 10-100 times lower). The proposal is an ideal first device to evaluate previously untested areas such as steady-state operation, plasma control, tritium operation, etc whilst producing at least 1 MW of fusion neutrons ideal for scientific research, materials tests, production of isotopes for medical and other applications, etc.

This design is made possible by a novel combination of new and established techniques over a wide range covering plasma initiation; ramp-up of plasma current; key methods of enhancing neutron production at relatively low current, field and auxiliary heating; use of improved energy confinement; means of varying the neutron energy in a controllable and tunable manner; efficient means of producing steady-state operation; methods of handling the exhaust heat load; special methods of construction, featuring shielding/reflectors to both protect coil windings and control the neutron output.

### Plasma Initiation:

methods include merging-compression; magnetic pumping whereby an oscillating current produces plasma rings which augment the plasma current; use of a retractable solenoid, or pair of such solenoids; Electron Bernstein Wave (EBW) current initiation by a gyrotron.

### Current Ramp-Up:

methods include retractable solenoid(s), which may be pre-cooled high temperature superconductor solenoids; EBW current drive; and the very efficient drive produced by heating the plasma so that the rapid increase in poloidal field necessary to contain the growing plasma inputs almost sufficient flux to ramp up the plasma current to the desired working value.

### Enhanced Neutron Production:

in a conventional fusion device nearly all neutron production arises from the central highest temperature region of the plasma. In the proposed device, most neutron production is from interaction of a very hot neutral beam (having energy>100 keV, preferably >130 keV) with the high-temperature tail of the Maxwellian plasma distribution. In addition, new modelling shows that neutron production is further enhanced by the relatively long path of the NBI beam when directed at optimum angle through the highly-elongated plasma (a natural feature of an ST) and by optimising the Tritium fraction.

### Variable Neutron Energy:

in a conventional fusion device the neutron energy is fixed at 14 MeV for D-T fusion and 2.5 MeV for D-D fusion. In one version of the proposed device an antenna configured to induce ion cyclotron resonance heating (ICRH) would be mounted inside the toroidal chamber. This ICRH system could also be configured to increase the energy of the emitted neutrons by several MeV in a controllable and tunable manner.

Optimising Neutron Output from D-D Fusion:

while D-T fusion is the best way to achieve the highest neutron flux and energy for some applications, it may be more effective to avoid the problems associated with tritium (eg cost, complexity, safety, regulation or availability) and instead use ICRH to increase neutron energy and/or to heat a D-D plasma to increase neutron flux. This use of ICRH can be combined with higher toroidal field and higher plasma current to give a surprisingly high neutron output from D-D Fusion in a system that may be more cost effective than a D-T Fusion system producing the same neutron flux.

### Favourable Confinement Scaling:

recent research suggests that energy confinement in an ST has a stronger dependence on magnetic field, and a lower dependence on plasma current, than the ITER scalings derived for conventional tokamaks. By increasing the toroidal field to 1.5 Tesla (at the major radius of 0.5 m) it is thus possible to obtain sufficient neutron production at plasma currents of 1.5 MA and possibly as low as 1 MA.

### Steady State Operation:

maintenance of the plasma current is a major demand on previous designs, where large currents of 6-12 MA are maintained by a combination of high ‘bootstrap’ current (which requires operation close to stability limits) and direct current drive from NBI (which requires costly NBI installations). The relatively low current in the present design (1-1.5 MA) considerably reduces these demands.

### Divertor Loads:

energy pumped into a plasma either to heat it or produce current drive emerges mainly along the scrape-off-layer (SOL) at the edge of the plasma, which is directed by divertor coils to localised divertor strike points. The power per unit area here is of critical concern in all fusion devices, and would not normally be acceptable in a small neutron source. However since the plasma current in the present proposal is very small the input power is greatly reduced (of order 6 MW, compared to tens of MW in other designs) so the divertor load is correspondingly reduced. Additional methods will be used to further reduce the load per unit area, by a combination of strike-point sweeping; use of the ‘natural divertor’ feature observed on START; and use of divertor coils to direct the exhaust plume (as advocated by Peng & Hicks [17]); possibly to expand the footprint to large radius as in the ‘super-X’ divertor advocated by Kotchenreuther et al. [18]. This latter normally requires large currents in the divertor control coils, as these have to be somewhat removed from the neutron source for protection: however this demand is made tractable here because of the very low plasma current required. Having used the above techniques to spread the heat load, further benefit may be gained by use of a flow of liquid Lithium over the target area.

### Construction Features:

insulation of the low-voltage Toroidal Field coil segments can be by stainless steel which combines great strength and relatively high resistance; the TF system may be demountable, utilising high-duty versions of the feltmetal sliding joints developed by Voss at CCFE; the device itself will feature a combination of heavy-water tanks and layers of lead shielding/reflectors to protect the PF coils and external TF coils from lower energy neutrons, and to direct the main stream of neutrons for research and processing tasks.

It is also possible to shoot positive ion beams directly into the plasma through iron tubes which shield out the magnetic field.

It will be appreciated that variations from the above described embodiments may still fall within the scope of the invention.

### REFERENCES

[1] McNamara B, ‘A briefing on futures with Fission & Fusion’, hosted at http://gtmhr.ga.corn as ‘Fission and Fusion Futures’
[2] G P Thompson & M Blackman 1946, M G Haines 1996 Plasma Phys. Control. Fusion 38 643
[3] R D Stambaugh et al, The Spherical Tokamak Path to Fusion Power', Fusion Technology Vol 33 P1 (1998)
[4] T C Hender et al, ‘Spherical Tokamak Volume Neutron Source’, Fusion Engineering and Design 45 (1990) p 265
[5] Jassby D L ‘Optimisation of Fusion Power Density in the Two Energy Component Tokamak Reactor’ Nuclear Fusion 1975 Vol 15 p 453
[6] B V Kuteev et al, ‘Plasma and Current Drive parameter options for a low-power Fusion Neutron Source’ 23rd IEEE/N PSS Symposium on Fusion Engineering, 2009. SOFE 2009.
[7] D L Jassby, Comments Plasma Phys. Controlled Fusion, 3 (1978) 151
[8] Y-K. M. Peng and D. J. Strickler, Nucl. Fusion 26, 769 (1986).
[9] M Gryaznevich at all, Phys. Rev. Letters, 80, (1998) 3972
[10] H R Wilson et al The Physics Basis of a Spherical Tokamak Component Test Facility Proc. 31^{st} EPS Conf 2004
[11] R M O Galvao et al, ‘Physics and Engineering Basis of a Multi-functional Compact Tokamak Reactor Concept’, paper FT/P3-20, IAEA conf 2008
[12] G M Voss et al, ‘Conceptual design of a Component Test Facility based on the Spherical Tokamak’, FED 83 (2008) p 1648
[13] Yichan Wu, Fusion Engineering and Design 63-64 (2002) 73/80
[14] L. J. Qiu et al., Advanced Study of Tokamak Transmutaton System, paper IAEA-CN-77/FTP2/09 presented at the 18th IAEA Fusion Energy Conf., Sorrento, Italy, Oct. 4-10, 2000.
[15] A Dnestrovskij et al, Plasma Devices and Operations, 15, 2007, p 1
[16] Y-K M Peng et al 2005 Plasma Phys. Control. Fusion 47 B263
[17] Y-K M Peng and J B Hicks: proceedings of the 16th Symposium on Fusion Technology, London, U.K., 3-7 Sep. 1990, Vol 2 p 1288
[18] M. Kotschenreuther, P. Valanju, S. Mahajan, L. J. Zheng, L. D. Pearlstein, R. H. Bulmer, J. Canik and R. Maingi ‘The super X divertor (SXD) and a compact fusion neutron source (CFNS)’ Nucl. Fusion 50 (2010) 035003 (8 pp)
[19] O. Mitarai and Y. Takase, Plasma current ramp-up by the outer vertical field coils in a spherical tokamak reactor, Fusion Sci. Technol. 43 (2003),
[20] V. Shevchenko, Nuclear Fusion Vol 50 (2010) p 22004

1. A compact nuclear fusion reactor for use as a neutron source comprising a toroidal plasma chamber and a plasma confinement system arranged to generate a magnetic field for confining a plasma in the plasma chamber, wherein:
the plasma confinement system is configured so that a major radius of the confined plasma is 0.75 m or less;
the reactor is configured to operate with a plasma current of 2 MA or less;
the magnetic field includes a toroidal component of 5 T or less.

2. The fusion reactor of claim 1, wherein the major radius of the confined plasma is less than 0.5 m.

3. The fusion reactor of claim 1, wherein the reactor is configured to operate with a plasma current less than 1.5 MA.

4. The fusion reactor of claim 1, which reactor is a spherical tokamak reactor.

5. The fusion reactor of claim 1, configured so that power input to the plasma is less than 10 MW.

6. The fusion reactor of claim 1, arranged to operate at a fusion output of at least 0.5 MW.

7. The fusion reactor of claim 1, wherein the magnetic field includes a toroidal component of 1.35 T or less.

8. The fusion reactor of claim 1, wherein the plasma is maintainable in a steady state for more than 10 seconds.

9. The fusion reactor of claim 8, wherein the plasma current is driven without induction.

10. The fusion reactor of claim 9, arranged to initiate the plasma using one or more of the following operations:
merging-compression;
magnetic pumping so that an oscillating current produces plasma rings to augment the plasma current;
activation of one or more retractable solenoids located in a central core of the toroidal chamber; and
Electron Bernstein Wave current initiation by a gyrotron.

11. The fusion reactor of claim 10, arranged to ramp up the plasma current using one or more of the following operations:
activation of the one or more retractable solenoids;
Electron Bernstein Wave current drive; and
heating the plasma so that a rapid increase in poloidal field necessary to contain the plasma as it grows inputs almost sufficient flux to ramp up the plasma current to a desired working value.

12. The fusion reactor of claim 10, wherein the one or more retractable solenoids include one or more pre-cooled high temperature superconducting solenoids.

13. The fusion reactor of claim 1, arranged to enhance neutron production by directing a neutral beam into the plasma so as to interact with the high-temperature tail of the Maxwellian plasma distribution.

14. The fusion reactor of claim 13, wherein the neutral beam has energy of at least 80 keV.

15. The fusion reactor of claim 14, wherein the neutral beam includes tritium atoms.

16. The fusion reactor of claim 14, wherein the plasma includes tritium ions.

17. The fusion reactor of claim 14, wherein the neutral beam includes deuterium atoms but not tritium atoms, and the plasma includes deuterium ions but not tritium ions.

18. The fusion reactor of claim 1, arranged to supply an output of neutrons of at least 1 MW.

19. The fusion reactor of claim 1, wherein the output neutrons are usable for one or more of:
formation of isotopes for medical and other use;
production of hydrogen;
production of heat for chemical engineering processes treatment of nuclear waste;
manufacture of tritium by neutron bombardment of lithium;
breeding of nuclear fission fuel;
materials analysis including neutron spectroscopy and/or neutron imaging and/or neutron activation analysis;
materials processing by neutron irradiation
detection of clandestine materials
medical imaging
medical therapy including neutron capture therapy and/or neutron beam therapy testing of materials and components; and
scientific research.

20. The fusion reactor of claim 1, wherein the plasma confinement system is configured so that a-particles generated in the plasma are not confined.

21. The fusion reactor of claim 1, wherein the plasma confinement system is configured so that no solenoid is located in the center of the toroidal plasma chamber when the reactor is in operation to fuse deuterium and tritium.

22. The fusion reactor of claim 1, further comprising divertors optimised to reduce the load per unit area on the walls of the plasma chamber.

23. The fusion reactor of claim 22, further comprising divertor coils configured to direct an exhaust plume of the plasma and expand a footprint of said exhaust plume to large radius and/or major radius and/or sweep the contact region over the divertors.

24. The fusion reactor of claim 22, wherein part or all of the surface of the divertors is coated with Lithium.

25. The fusion reactor of claim 1, further comprising an antenna configured to induce ion cyclotron resonance heating (ICRH) and configured to increase the energy of the emitted neutrons in a controllable and tunable manner.

26. The fusion reactor of claim 1, wherein the vertical elongation of the confined plasma at a separatrix that separates a core plasma and a region of open magnetic field lines is about 3.

27. The fusion reactor of claim 1, further comprising a multiplier blanket configured to increase the flux of emitted neutrons.

28. The fusion reactor of claim 1, further comprising reflectors to direct neutrons out of the reactor so as to produce a local increase in flux density.

29. A method of generating neutrons by operating a nuclear fusion reactor comprising a toroidal plasma chamber, the method comprising:
initiating a plasma in the plasma chamber;
generating a magnetic field with a toroidal component of 5 T or less to confine the plasma in the plasma chamber, the plasma having a major radius of 0.75 m or less;
ramping a plasma current in the plasma up to 2 MA or less; and
emitting neutrons.

30. The method of claim 29, wherein the major radius of the confined plasma is less than 0.5 m.

31. The fusion reactor of claim 29, wherein the reactor is configured to operate with a plasma current less than 1.5 MA.

32. The method of claim 29, further comprising inputting energy to the plasma at less than 10 MW.

33. The method of claim 29, further comprising maintaining the plasma in a steady state for at least 10 seconds.

34. The method of claim 29, wherein the plasma is initiated using one or more of the following operations:
merging-compression;
magnetic pumping so that an oscillating current produces plasma rings to augment the plasma current;
activation of a one or more retractable solenoids located in a central core of the toroidal chamber; and
Electron Bernstein Wave current initiation by a gyrotron.

35. The method of claim 29, wherein the plasma current is ramped up using one or more of the following operations:
activation of the one or more retractable solenoids;
Electron Bernstein Wave current drive; and
heating the plasma so that a rapid increase in poloidal field necessary to contain the plasma as it grows inputs almost sufficient flux to ramp up the plasma current to a desired working value.

36. The method of claim 29, wherein the one or more retractable solenoids include one or more pre-cooled high temperature superconducting solenoids.

37. The method of claim 29, further comprising directing a neutral beam, having energy at least 100 keV, into the plasma so as to interact with the high-temperature tail of the Maxwellian plasma distribution and enhance neutron production.

38. The method of claim 29, wherein the neutrons are generated at a rate of at least 3×10¹⁷ neutrons per second.

39. The method of claim 29, wherein at least one of the neutral beam and the plasma comprises tritium.

40. The method of claim 29, wherein the neutral beam and plasma each comprise deuterium only so that fusion operates as a D-D reaction.

41. The method of claim 29, further comprising using the neutrons for one or more of:
formation of isotopes for medical and other use;
production of hydrogen;
production of heat for chemical engineering processes
treatment of nuclear waste;
manufacture of tritium by neutron bombardment of lithium;
breeding of nuclear fission fuel;
materials analysis including neutron spectroscopy and/or neutron imaging and/or neutron activation analysis;
materials processing by neutron irradiation
detection of clandestine materials
medical imaging
medical therapy including neutron capture therapy and/or neutron beam therapy testing of materials and components; and
scientific research.
